(19) United States
(12) Patent Application Publication
(10) Pub. No.: US 2002/0129050 A1
(43) Pub. Date: Sep. 12, 2002

(54) Displaying video in application

(76) Inventor: Paul S. Gryskiewicz, Chandler, AZ (US)

Correspondence Address: Timothy N. Trop, TROP, PRUNER & HU, P.C., STE 100, 8554 KATY FWY, HOUSTON, TX, 77024-1805, US

(21) Appl. No.: 09/803,530

(22) Filed: Mar. 9, 2001

(51) Int. Cl. G06F 17/21

(52) U.S. Cl. 707/500.1; 707/526

(57) ABSTRACT

A way of displaying video in an application is described. An apparatus is provided that comprises an interface to receive video. The apparatus further comprises a controller to display at least one object. The controller is further provided to display the video, wherein a position of the at least one object is adjusted in response to displaying the video.

### BACKGROUND

This invention relates generally to displaying video in an application executable on a processor-based system.

Improvements in video technology have made it possible to employ video in a variety of applications, including in software applications executing on processor-based systems, such as personal computers. For example, a television software application may be used to display television (TV) signals received through a TV tuner card, which may be installed in a processor-based system, for instance. Alternatively, a video application may display video received over a network, such as the Internet. As utilized herein, the term “video application” refers to any application capable of displaying video on a display device.

With the versatility of today's processor-based systems, a user may view video as well as perform a variety of other tasks on the processor-based system, such as word processing, browsing the Internet, electronic mail processing, and the like. In some instances, however, it may be difficult for the user to perform the task at hand while also being able to view the video, as the video window may be hidden in the back ground, behind windows of other applications, such as a word processor, electronic mail application, web browser, and the like. In order to be able to view the video while performing other tasks, the user may have to painstakingly arrange the applications on the display such that all the desired windows are viewable. Arranging the windows in a desired manner, however, may not only be time consuming but may also require the user to reduce the size of the windows to enable the windows to fit the viewable region on the display device.

Thus, there is a need to display video on a processor-based system that may be conveniently viewed.

### BRIEF DESCRIPTION OF THE DRAWINGS

The invention may be understood by reference to the following description taken in conjunction with the accompanying drawings, in which like reference numerals identify like elements, and in which:

FIG. 1 is a stylized block diagram of a communications system, in accordance with one embodiment of the present invention;

FIG. 2 is a block diagram of a processor-based system that may be employed in the communications system of FIG. 1, in accordance with one embodiment of the present invention;

FIG. 3 is a flow chart of one embodiment of software resident on the processor-based system of FIG. 2;

FIG. 4 is an example of a text object shown in a window of the software of FIG. 3, in accordance with one embodiment of the present invention;

FIG. 5 is an example of an arrangement of a text and video object shown in the window of the software of FIG. 3, in accordance with one embodiment of the present invention;

FIGS. 6A-6B illustrate a flow chart of an alternative embodiment of software resident on the processor-based system of FIG. 2;

FIG. 7 is an example arrangement of the text object shown in the window of the software of FIG. 2 in response to the video object being moved within the window, in accordance with one embodiment of the present invention; and

FIG. 8 is an example arrangement of the text object shown in the window of the software of FIG. 2 in response to re-sizing the video object, in accordance with one embodiment of the present invention.

### DETAILED DESCRIPTION

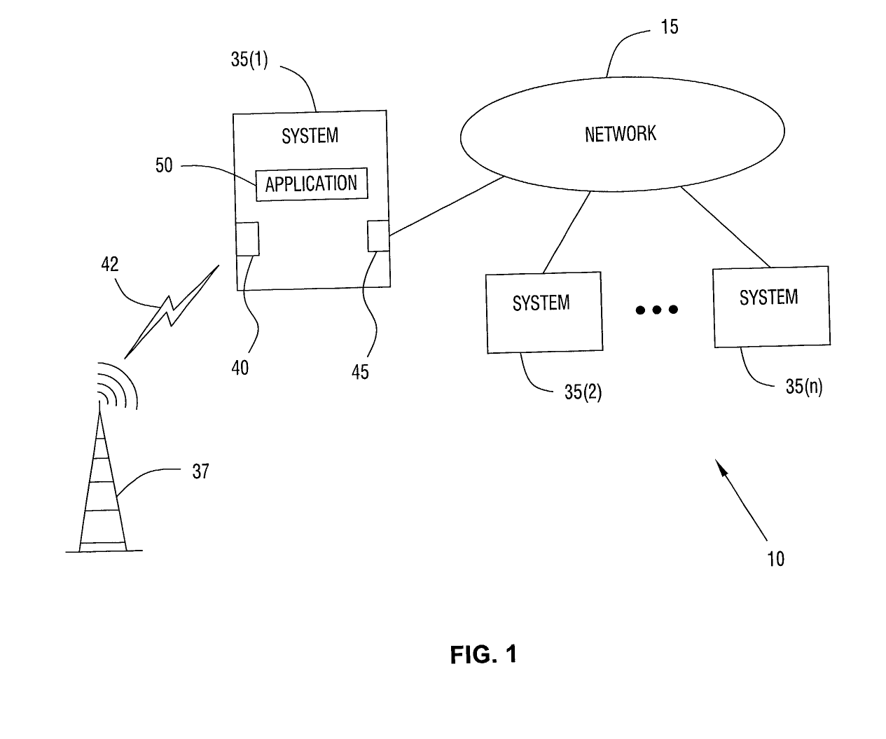

Referring now to FIG. 1, a block diagram of a communications system 10 in accordance with one embodiment of the present invention is illustrated. The communications system 10, in one embodiment, includes a network 15 that may be coupled to a plurality of processor-based systems 35(1−n). In an alternative embodiment, one or more of the processor-based systems 35(1−n) may be standalone devices, and may not be coupled to the network 15. The data network 15 may be a public network, such as the Internet.

In one embodiment, the processor-based system 35(1−n) may be a laptop computer, desktop computer, main frame computer, television with a setup box, an Internet appliance, or any other device that is capable of receiving video signals.

In one embodiment, the communications system 10 includes a transmitter 37 for broadcasting television signals, which may then be received by one or more of the processor-based systems 35(1−n).

The processor-based system 35(1), in one embodiment, includes a television tuner interface 40 for receiving television broadcast signals over a wireless link 42. In one embodiment, the processor-based system 35(1) may include a network interface 45 for interfacing with the network 15. The network interface 45 may, in one embodiment, receive information comprising text, images, and/or video signals over the network 15.

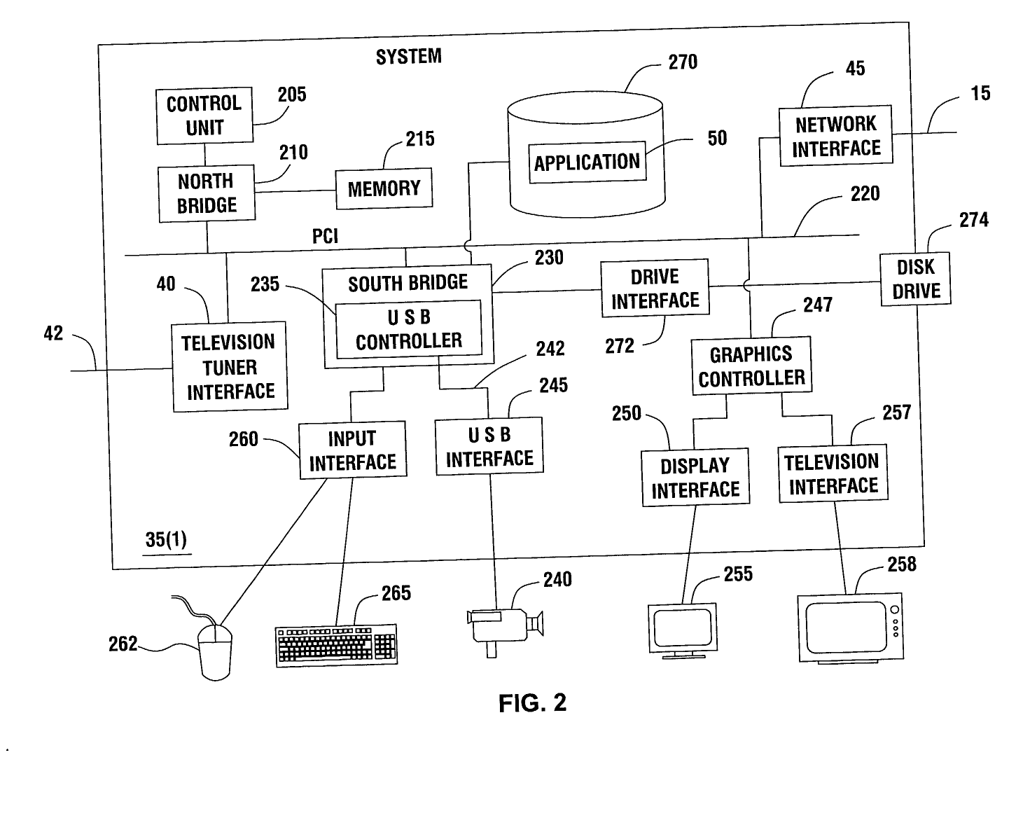

Referring now to FIG. 2, one embodiment of the processor-based system 35(1) is illustrated. The processor-based system 35(1) comprises a control unit 205, which in one embodiment may be a processor. The control unit 205 in one embodiment may be capable of interfacing with a north bridge 210. The north bridge 210 may provide memory management functions for memory 215, as well as serve as a bridge to a peripheral component interconnect (PCI) bus 220. The processor-based system 35(1) includes a south bridge 230 coupled to the PCI bus 220, in one embodiment. The south bridge 230, in one embodiment, includes a Universal Serial Bus (USB) host controller 235 that may be coupled to an imaging device 240 by a universal serial bus 242 through an USB interface 245.

In one embodiment, the imaging device 240 may be a video camera capable of capturing and providing video signals to the USB interface 245. Although the imaging device 240 is illustrated as being coupled to the processor-based system 35(1) via the USB interface 245, in alternative embodiments, the imaging device 245 may be coupled to the processor-based system 35(1) through other means, such as a serial (RS232) port, parallel port, video input capture port, and the like.

In one embodiment, the processor-based system 35(1) includes the television tuner interface 40 that may be coupled to the PCI bus 220. In one embodiment, the television tuner interface 40 may include a television tuner card. The processor-based system 35(1), in one embodiment, includes the network interface 45 that may be coupled to the PCI bus 220. The network interface 45, in one embodiment, may include a network card. The television tuner interface 40 and the network interface 45 may be adapted to receive video signals over the link 42 and the network 15, respectively.

The processor-based system 35(1) may include a graphics controller 247 that may be coupled to a display interface 250 and a television interface 257, in one embodiment. In one embodiment, the graphics controller 247 is capable of processing graphics for the processor-based system 35(l). The output interface 250 may interface with a display device 255 on which images captured by the imaging device 240 may be displayed. The television interface 257 may interface with a television 258, in one embodiment. The display device 255 and the television 258 may be capable of displaying text and/or video. Video received by the television tuner interface 40 and/or the network interface 45 may be displayed on at least one of the display device 255 and television 258.

In one embodiment, the processor-based system 35(1) may include an input interface 260 that is coupled to the south bridge 230. The input interface 260 may be capable of interfacing with one or more input devices, such as a mouse 262 or a keyboard 265.

The processor-based system 35(1) includes a storage unit 270 that is coupled to the south bridge 230, in one embodiment. The storage unit 270 may have an application 50 that is capable of displaying video in a window having text and/or one or images, as is described in more detail below. The application 50 may be any one of a variety of applications, such as a word processor, spread sheet, web browser, electronic mail processing application, or any application being capable of executing on the processor-based system 35(1). In one embodiment, the application 50, when executed on the processor-based system 35(l), opens a window in which text, images/graphics, video, and the like may be displayed. In one embodiment, the application 50 may operate at a ring 3 level. The storage unit 270 may include in one embodiment an operating system, such as the WINDOWS® operating system provided by Microsoft Corporation.

In one embodiment, the processor-based system 35(1) includes a drive interface 272 that interfaces with a disk drive 274. The disk drive 274 may be a compact disc read only memory (CDROM) drive, a digital video disk (DVD) drive, a diskette drive, and the like. In one embodiment, video played on the disk drive 274 may be displayed on the display device 255 or the television 258.

For clarity and ease of illustration, only selected functional blocks of the processor-based system 35(1) are illustrated in FIG. 2, although those skilled in the art will appreciate that the processor-based system 35(1) may comprise additional functional blocks. Additionally, it should be appreciated that FIG. 2 illustrates one possible configuration of the processor-based system 35(1) and that other configurations comprising different interconnections may also be possible without deviating from the spirit and scope of one or more embodiments of the present invention. For example, in an alternative embodiment, the display controller 257 may be coupled to the north bridge 210 directly (as opposed to the PCI 220). As an additional example, the USB controller 235 may be implemented outside the south bridge 230, in one embodiment. Similarly, other elements of the processor-based system 35(1) may be configured differently.

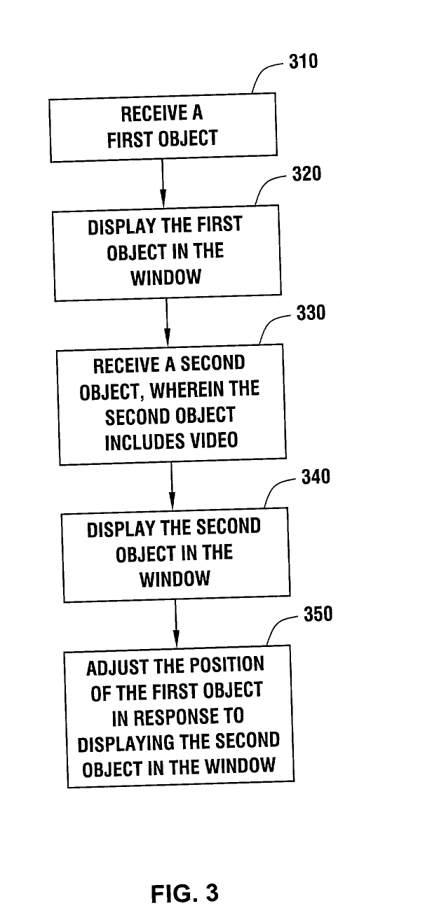

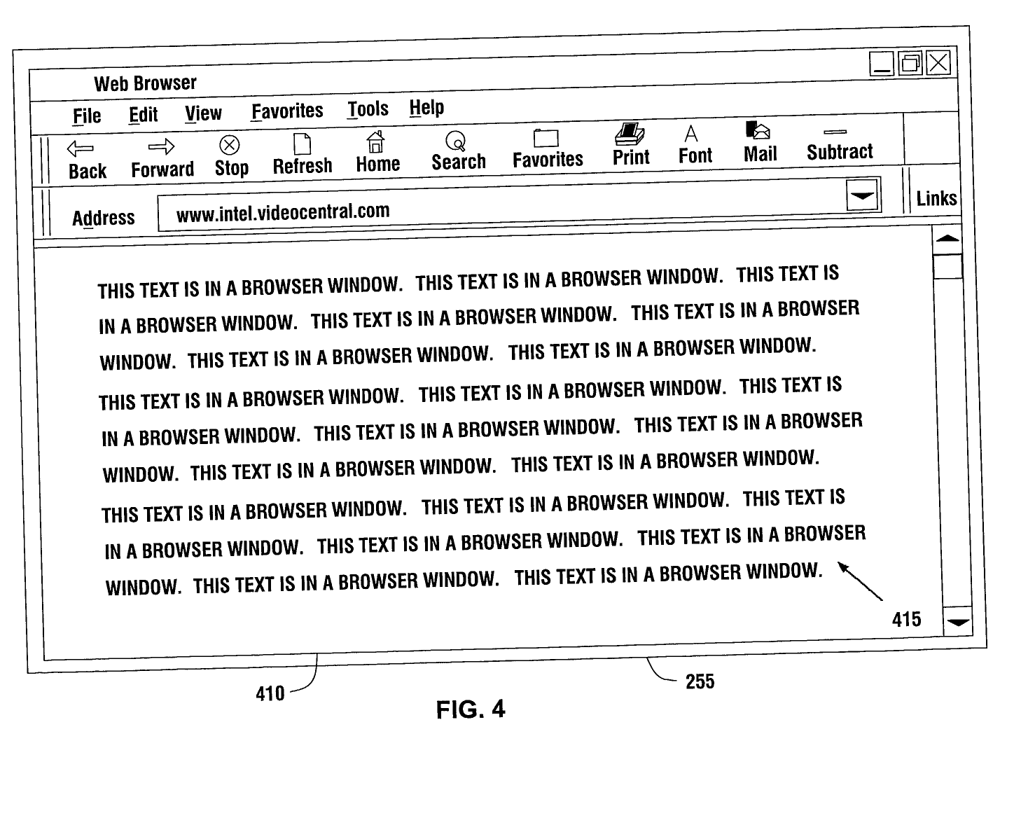

Referring now to FIGS. 3-5, a flow diagram of the application 50 (see FIG. 2) is illustrated, in accordance with one embodiment of the present invention. Although not so limited, in the illustrated embodiment the application is a web browser application. The application 50 of the processor-based system 35(1) receives (at 310) a first object 415 (see FIG. 4—described below) for displaying in the application's window on the display device 255 (see FIG. 2). The first object 415 may include text, images/graphics, video, or a combination thereof. In one embodiment, the first object 415 may comprise a portion of information that is received over the network 15, from a website, for example. Alternatively, if the application 50 is a word processor, for example, then the first object 415 may be a portion of the text of a file being edited. The application 50 displays (at 320) the first object 415 in its window 410, as shown in FIG. 4, for example.

FIG. 4 illustrates the application (e.g., browser) window 410 in which a sample text “THIS TEXT IS IN A BROWSER WINDOW” is repeated. This repeated text may be one example of the first object 415 that is displayed (at 320—see FIG. 3). It should be understood that the term “object” does not necessarily refer to any specific text or image, but, instead, may refer to text/image (or a portion thereof) that is being displayed in the application window 410 at any given time, in one embodiment.

Referring again to FIG. 3, the application 50 receives (at 330) a second object 515 (see FIG. 5—described below) for displaying in the application window 410 (see FIG. 4), wherein the second object 515 includes video. The video may be received from one of a variety of sources, including from the imaging device 240, the network interface 45, the television tuner interface 40, and/or the disk drive 274 of FIG. 2. In other embodiments, the video may be received from other suitable means.

The application 50 displays (at 340) the second object 515 in the application window 410 and adjusts (at 350) the position of the first object 415 in response to displaying (at 340) the second object 515 in the application window 410, as shown in FIG. 5. FIG. 5 illustrates that the second object 515 (e.g., video) is displayed in a right-hand corner of the application window 410, and the first object 415, (e.g., text) is adjusted so that both the first and second objects 415, 515 are viewable, in one embodiment. It should be understood that the contents of the second object 515 might change with time, as new video is received for displaying in the application window 410. As such, the term “the second object” 515 may refer to information being displayed in the application window 410 during a given time.

Referring now to FIGS. 6A-6B, 7, and 8, FIGS. 6A-6B illustrate a flow diagram of an alternative embodiment of the application 50. The application 50 displays (at 610) a first object 710 (see FIG. 7) in the application window 410 (see FIG. 4), wherein the first object 710 includes video, in one embodiment. The application 50 receives (at 615) a second object 715 (see FIG. 7), wherein the second object 715 includes at least one of text and image. The application 50 displays (at 620) the second object 715 (e.g., text, image) based on the location of the first object 710 (e.g., video), wherein both the first and second objects 710, 715 may be viewed substantially concurrently in the application window 410. In one embodiment, the application 50 positions the second object 715 in a manner so as to not overwrite the window space occupied by the first object 710.

The application 50 determines (at 625) whether a user wishes to adjust the first object 710, wherein the adjusting may include, but is not limited to, moving the first object 710, re-sizing the first object 710, or even removing the first object 710 from the application window 410. In accordance with one embodiment of the present invention, the user may manipulate that first object 710 in any manner a window may be manipulated in the WINDOWS® operating system.

If the user does not wish to adjust the first object 710 (e.g., video), then the application 50 continues (at 630) displaying the first and second objects 710, 715 in the application window 410. If the user wishes to adjust the first object 710, then the application 50 determines (at 635) if the user wishes to move the first object 710. If yes, then the application allows (at 640) the user to move the first object 710 to a desired location. The first object 710 may be moved, in one embodiment, by selecting the first object 710 using the mouse 262 (see FIG. 2) and then dragging the first object 710 to the desired location within the application window 410. In one embodiment, the application adjusts (at 645) the second object 715 (e.g., text, images) in response to the first object 710 being moved, as shown in FIG. 7 (discussed below). After adjusting (at 645) the second object 715, the application 50 continues (at 630) with its operation, in one embodiment.

FIG. 7 illustrates an example arrangement of the first object 710 being moved to a different location. As can be seen, when the first object 710 is moved towards the middle of the application window 410, the second object 715 is rearranged so that it is not obscured by the first object 710. In the illustrated embodiment, the text 715 is adjusted in a manner so that both the text 715 and video 710 are viewable in the application window 410. In an alternative embodiment, the first object 710 may comprise text and/or images but no video.

Referring again to FIG. 6B, upon determining that the user does not wish to move the first object 710, the application 50 determines (at 650) if the user wishes to re-size the first object 710. If yes, the application 50 allows the user to re-size the first object 710 to a desired size. The first object 710 may be re-sized, for example, by selecting one of the sides of the first object 710 using the mouse 262 (see FIG. 2) and dragging the selected side until the first object 710 is enlarged or reduced to the desired size. Based on re-sizing of the first object 710, the application 50 adjusts (at 660) the second object 715, as shown in FIG. 8 (discussed below) After adjusting (at 660) the second object 715, the application 50 continues (at 630) with its operation, in one embodiment.

FIG. 8 illustrates an example arrangement of the first object 710 being re-sized to a user-selected size. As can be seen, when the first object 710 is enlarged, the application 50 rearranges the second object 715 so that the second object 715 is not obscured by the first object 710. In the illustrated embodiment, because of the large size of the re-sized first object 710, the entire second object 715 (e.g., text) is not displayable in the application window 410. As such, the application 50, in one embodiment, moves the undisplayed portion of the second object 715 to a next page of the application window 410. The undisplayed portion of the second object 715 may be viewed by scrolling down the application window 410 using the scroll bar 810, in one embodiment. As the text is scrolled, the application 50, in one embodiment, arranges the text “around” the video object. Thus, in accordance with one embodiment of the present invention, the application 50 enables a user to view both the first and second objects 710, 715 in the application window 410.

Referring again to FIG. 6B, the application 50 allows (at 665) a user to remove the first object 710 from the application window 410. In response to removing the first object 710, the application 50, in one embodiment, adjusts (at 670) the position of the second object 715 so that the space that was otherwise consumed by the first object 710 is now used for displaying the second object 715 (e.g., the text). The application 50, in one embodiment, continues (at 630) with further processing after adjusting (at 670) the second object 715.

In one embodiment, the application 50 allows a user to scroll through the application window 410 in which the video object is also being displayed. As the user scrolls through the application window 410, the application 50 displays, in one embodiment, text in a manner that does not interfere with the portion of the application window 410 showing the video. The new text displayed during scrolling may be considered as receiving a new second object 715 (i.e., see block 615 of FIG. 6A), in one embodiment. The scrolling may occur on a line by line basis, or, alternatively on a page by page basis, in one embodiment.

For illustrative purposes, the application window 410 has been shown on the display device 255; however, in other embodiments, the application window may also be displayed on the television 258 alone or on both the display device 255 and the television 258.

The various system layers, routines, or modules may be executable control units (such as the control unit 205 (see FIGS. 2)). Each control unit may include a microprocessor, a microcontroller, a processor card (including one or more microprocessors or controllers), or other control or computing devices. The storage devices referred to in this discussion may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions when executed by a respective control unit cause the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. An apparatus comprising:
an interface to receive video; and
a controller to:
display at least one object and the video; and
adjusting a position of the at least one object in response to displaying the video.

2. The apparatus of claim 1, wherein the controller adjusts the position of at least one of an image or text in response to displaying the video.

3. The apparatus of claim 1, wherein the controller adjusts the position of the object in response to adjusting at least one of location and size of the video.

4. The apparatus of claim 1, wherein the controller allows the video to be displayed while the contents of the object are updated.

5. The apparatus of claim 1, wherein the controller displays the video in a window of at least one of a word processor, an application to browse the Internet, and electronic mail processing application.

6. The apparatus of claim 1, wherein the interface receives the video over a wireless link.

7. The apparatus of claim 1, wherein the interface comprises at least one of a television tuner card and a disk drive.

8. The apparatus of claim 1, wherein the interface receives the video over a network.

9. The apparatus of claim 1, wherein the interface receives the video over a universal serial bus.

10. A method, comprising:
displaying an object on a display; and
adjusting the object on the display in response to displaying video on the display.

11. The method of claim 10, wherein displaying the object comprises displaying at least one of text and image on the display.

12. The method of claim 10, wherein adjusting the object comprises arranging the object in a manner so that both the video and the object are viewable.

13. The method of claim 10, further comprising adjusting the object in response to moving the video on the display.

14. The method of claim 10, further comprising adjusting the object in response to altering the size of the video on the display.

15. The method of claim 10, wherein adjusting the object comprises adjusting the object in response to displaying video received from a disk drive.

16. The method of claim 10, wherein adjusting the object comprises adjusting the object in response to displaying video received over at least one of a network a universal serial bus, and a wireless link.

17. An article comprising one or more machine-readable storage media containing instructions that when executed enable a processor to:
display video in a window; and
display text in the window, wherein the text is displayed in a manner that allows both the text and the video to be viewable in the window.

18. The article of claim 17, wherein the instructions when executed enable the processor to display the video in the window of an Internet browsing application.

19. The article of claim 17, wherein the instructions when executed enable the processor to display the video in the window of at least one of a word processor and electronic mail application.

20. The article of claim 17, wherein the instructions when executed enable the processor to adjust the text in the window in response to changing the position of the video in the window.

21. The article of claim 20, wherein the instructions when executed enable the processor to adjust the text in the window in response to altering the size of the video in the window.

22. The article of claim 17, wherein the instructions when executed enable the processor to display the video received from at least one of a wireless link, a network, a disk drive, and a universal serial bus.

23. A method comprising:
displaying text in a window of a software application executing on a processor-based device;
displaying video in the window of the software application; and
arranging the text, in response to displaying the video in the window, in a manner that both the text and video are viewable.

24. The method of claim 23, further comprising displaying one or more images in the window, wherein the text, the one or more images, and the video are viewable substantially simultaneously viewable.

25. The method of claim 23, further re-sizing the video in the window and arranging the text in response to re-sizing the video in the window in a manner that both the text and re-sized video are in view.

26. An apparatus, comprising:
an interface to receive a video signal;
a controller to:
display a web browser application having at least text;
display the video signal in a video portion of the web browser application; and
adjust the at least text in response to displaying the video portion to allow both the text and the video signal to be viewed substantially simultaneously.

27. The system of claim 26, wherein the controller:
allows re-sizing the video portion in the web browser application; and
adjusts the text in response to re-sizing the video portion.

28. The system of claim 26, wherein the controller:
allows moving of the video portion within the web browser application; and
adjusts the text in response to moving the video portion within the web browser application.

29. An article comprising one or more machine-readable storage media containing instructions that when executed enable a processor to:
display a first object in a window;
display a second object in the window; and
enable scrolling of the first object in the window, wherein the first object scrolls around the second object in response to scrolling.

30. The article of claim 29, wherein the instructions when executed enable the processor to display the first object comprising at least text and to display the second object comprising video.
